(19) United States
(12) Patent Application Publication
(10) Pub. No.: US 2005/0211634 A1
(43) Pub. Date: Sep. 29, 2005

(54) CONTROL SYSTEM AND METHOD FOR WASTEWATER TREATMENT

(76) Inventor: Dwain E. Morse, Santa Barbara, CA (US)

Correspondence Address: KELLY LOWRY & KELLEY, LLP, 6320 CANOGA AVENUE, SUITE 1650, WOODLAND HILLS, CA, 91367, US

(21) Appl. No.: 10/908,701

(22) Filed: May 23, 2005

Related U.S. Application Data
(63) Continuation-in-part of application No. 10/810,295, filed on Mar. 25, 2004.
(63) Continuation-in-part of application No. 10/810,928, filed on Mar. 25, 2004.

(51) Int. Cl. C02F 1/24

(52) U.S. Cl. 210/704; 210/739

(57) ABSTRACT

A system and method is provided for optimizing chemical additions, mixing energy and other variables while treating a contaminated liquid stream. Samples from the contaminated liquid stream are tested to determine the optimal parameter for each variable, including type and amount of chemistry added, chemistry sequence, mixing energy and time, temperature, pressurization, etc. A system of mixing devices, flotation chamber, and other components are designed and modified to achieve optimal results based on the prior testing. The system can be modified over time in response to the changing contaminated liquid stream.

### BACKGROUND OF THE INVENTION

The present invention generally relates to wastewater treatment. More particularly, the present invention relates to a control system for wastewater treatment which monitors and adjusts variables in a unique flotation system so as to optimize waste removal.

Industrial wastewater treatment presents many challenges to current technologies. Contaminants are often present in the form of suspended solids. Such solids range in size from macroscopic (inches to hundreds of microns) to colloidal (sub-micron) or even nanoscopic particles. Immiscible oils and other oil loving substances (termed hydrophobic) are also sometimes present and emulsified (solubilized) with the addition of appropriate emulsifying agents—(surfactants [detergents] or surface active polymers). It is imperative to remove such contaminants with a cost-effective, reliable process and technology.

Numerous technologies have been developed to achieve efficient solid/liquid separation in industrial wastewater treatment facilities. Historically, gravimetric separations are most commonly used. Sedimentation in large clarifier tanks is used to separate particles with densities greater than water.

In addition to gravimetric preparation systems, fine mesh screens or membranes are used to separate the suspended solids (as small as 50 microns) where the particles are not attracted to the screens, thus causing plugging and impeding the continual flow of the system.

On the other hand, flotation is used to float particles that have densities close to that of water, such as fats, oils, and grease, or particles with densities that are greater than water such as dirt, heavy metals and minerals. Flotation is a process in which one or more specific particle constituents of a slurry (or suspension of finely dispersed particles or droplets) become attached to gas bubbles so that they can be separated from water or other constituents. The gas/particle aggregates then float to the top of the flotation vessel where they may be separated from water and other non-floatable constituents.

Most wastewater solid and emulsified components such as soil particles, fats, oils and greases are charged. Wastewater processing/treatment chemicals/additives such as coagulants and flocculants are added to neutralize, charge and initiate nucleation and growth of larger colloidal and suspended particles, the so-called flocs. Flocs can range in size from a millimeter to centimeters in diameter when coagulation and flocculation processes are optimized. Too much chemical will recharge flocs and result in their break up or permanent destruction of the flocs (overcharged particles and/or flocs repel each other and tend to stay apart).

Coagulants (chemicals used to neutralize particle charge) can be inorganic salts such a ferric chloride or polymers such as cationic polyamines. Such chemicals are often viscous requiring adequate mixing time and energy to mix them homogeneously with the incoming wastewater stream. Adding excess chemicals to the contaminated water can result in wasting chemicals and/or creating contaminated discharge water. Too much mixing energy on the other hand can result in the irreversible break up of the flocs and inefficient solid-liquid separation.

Flocculants are large molecular weight polymers used to collect the smaller coagulated flocs into large size stable flocs, facilitating solid/liquid separation. These large molecules are often coiled and have to be uncoiled plus thoroughly mixed with the incoming coagulated wastewater stream. Too much energy or mixing time results in a break up of flocs and too little energy results in inadequate mixing or coiling of the polymer strands.

Current technologies are not satisfactory in their ability to respond fast to a changing wastewater influent. The mixing of chemical additives is often physically destructive. It is often inefficient and generally requires a long time, causing real life flotation, sedimentation or screening systems to be extremely large, taking up valuable real estate inside the manufacturing facilities. This time delay in turn creates a possibility that the contaminated stream has changed again and the operator is correcting in the wrong direction.

Accordingly, what is needed is a system for creating an optimum amount of coagulants and flocculants in both quantity and ration of these chemicals, pH, mixing time, temperature and energy which are matched with pressurization and depressurization and energy so as to create bubbles that are the right size to attach to the flocs and create bubbles that grow into larger bubbles after attaching to flocs. The system should be adapted to change these variables as the wastewater stream changes over time. This ensures flotation of the floc clusters out of the water, and replacement of much of the entrained water in the floc cluster with air. The present invention fulfills these needs and provides other related advantages.

### SUMMARY OF THE INVENTION

The system of the present invention is designed to optimize the chemical additions (coagulation, flocculation and pH) as well as the mixing energy (both time and magnitude) and the temperature of the contaminated stream to optimize the cost of chemical usage versus the characteristics of the system discharge water.

The system sequence of the present invention is generally as follows: first, samples from the operating stream are taken at different times of the day. Bench test analysis procedures are used to rank impact order for each energy variable. A starting setting for all control parameters are established using these samples.

Based on performance objectives (cost of chemicals compared to discharge requirements), directions are established to operate, measure and adjust variable parameters as needed. The start-up system turbidity (or any other parameter that may be translated into the real time contamination level of the discharged water) is measured at a nucleation chamber exit. A controller is programed to first change the charge satisfaction chemical additive. If the turbidity reads over target, the quantity or delivery sequence is changed by adding charge satisfaction chemistry to one or more mixing heads. The sequence and amount program are based on the bench test analysis performed previously. By trial and error, the optimum combination of mixing energy and time of exposure to the stream generates the largest turbidity with minimum costs. The controller is programed to repeat this process by varying the next ranking energy variable identified in the bench test analysis of the stream, until all of the variables are taken into account.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIGS. 1A-1C are graphs illustrating charted variables of chemistry, mixing time, and mixing speed, in accordance with the present invention;

FIG. 2 is a cross-sectional view of a mixing apparatus used in accordance with the present invention;

FIG. 3 is a diagrammatic view of a plurality of mixing devices fluidly connected to one another, in accordance with the present invention;

FIG. 4 is a diagrammatic view of the plurality of mixing devices and a flotation tank, and a servo director controller operably connected thereto and other components to accomplish the present invention;

FIG. 5 is a diagrammatic view of a testing procedure used in accordance with the present invention;

FIGS. 6A-6D are diagrammatic views illustrating the selective flow through mixing apparatuses, in accordance with the present invention; and

FIGS. 7A-7S are graphs illustrating optimization of various variables for treating the wastewater, in accordance with the present invention.

### DETAILED DESCRIPTION OF THE PREFERRED EMBODIMENTS

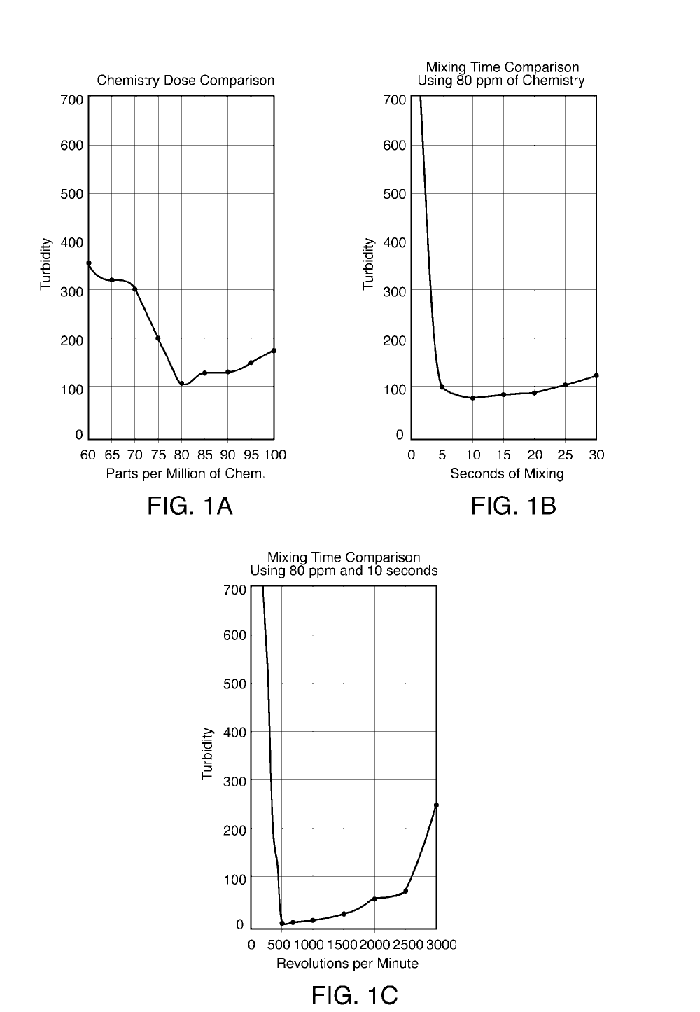

As shown in the accompanying drawings, for purpose of illustration, the present invention is directed to a control system for wastewater treatment. Those skilled in the prior art claim that longer mixing time (1-60 minutes) at a lower mixing energy (e.g., 200 r.p.m. of a mechanical mixer) is needed for optimum flocculation. With reference to FIGS. 1A-1C, we have determined that this is not the case. For a given wastewater stream, there is an optimal chemistry dosage in parts per million of the chemistry.

For example, as illustrated in FIG. 1A, a dosage of 80 parts per million of the chemistry is more effective than 70 parts per million, as anticipated, but has also been found to yield better results than 100 parts per million. Similarly, there is an optimal time for mixing as well as a mixing speed or revolutions per minute, as illustrated in FIGS. 1B and 1C. Mixing too slow, or for an insufficient time, yields inferior results, as does mixing too fast and too long. In fact, it has been found that relatively short mixing times of five to ten seconds with high mixing energies (500-2000 r.p.m. with a mechanical mixer) yielded cleaner water with lower turbidity and larger flocs which were easier to float than with the systems utilizing conventional wisdom. In fact, there are many variables, as will be fully described herein, which can be adjusted to optimize the removal of the contaminants from the liquid stream. The present invention addresses the consideration of each of these, and discloses an automatic controller system for adjusting these variables over time as the wastewater stream changes in characteristic. For example, in a manufacturing facility, the wastewater stream generated between 9:00 a.m. and 12:00 p.m. may be different than that generated between 12:00 p.m. and 2:00 p.m., when workers may be taking lunch breaks, certain procedures are not being performed, etc. Also, the wastewater stream may vary according to the processes performed throughout the day.

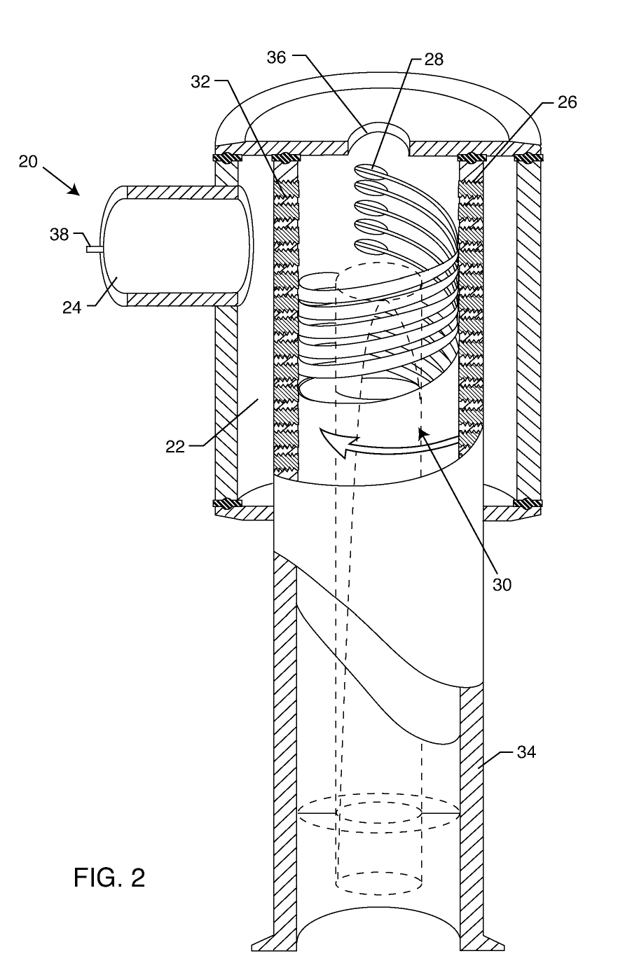

With reference to FIG. 2, a mixing apparatus 20 used in accordance with the present invention is illustrated. This mixing apparatus 20 is a hydrocyclone, but unlike a single “hydrocyclone” the mixing apparatus 20 has a two-stage delivering mechanism. This mixing apparatus 20 is fully disclosed in pending U.S. Application Serial Nos. 10/810,295 and 10/810,928, the contents of which are hereby incorporated by reference in full.

Briefly, the mixing device 20 delivers liquid into a receiving chamber port plenum 22 through an inlet thereof 24. This plenum spreads the liquid evenly around a central cartridge 26, so that the flow of liquid is equalized around the cartridge 26. Once the flow is uniformly distributed around the cartridge 26, the liquid can pass through a series of tangential ports 28 that are drilled and tapped into the cartridge 26. The ports direct the liquid into a cyclonic spin chamber 30 at a tangent. The cartridge 26 may be configured as any multi-sided block, wherein each facet of the cartridge 26 has a plurality of tangential holes or ports 28 that provides pathways through which the liquid can pass. The alignment of the pathways from facet to facet can be uniform or staggered to minimized the ridges in the center spinning cyclonic chamber 30.

The ports 28 are preferably threaded or the like in order to accommodate fluid flow resistant plugs 32 to be removably inserted therein. Inserting or removing these plugs 32 at a given constant flow rate increases or decreases the energy imparted to the spinning fluid.

The diameter of the central cyclonic spin chamber 30 is determined by the flow range that the mixing unit 20 is likely to be exposed to. Although there is a wide range of flows that a given diameter unit can properly handle, when that flow rate range is exceeded, the given mixing apparatus 20 will require replacement by a larger or smaller diameter apparatus. Typically, such flow ranges are as follows:
0.1 to 10 gpm flows require a cyclonic chamber with a 1″ diameter;
5 to 80 gpm flows require a cyclonic chamber with a 2″ diameter;
50 to 150 gpm flows require a cyclonic chamber with a 2.5″ diameter;
70 to 250 gpm flows require a cyclonic chamber with a 3″ diameter;
200 to 800 gpm flows require a cyclonic chamber with a 4″ diameter; and
500 to 2000 gpm flows require a cyclonic chamber with a 6″ diameter.

Typically, the upper range of these flow rates are not limited by the cyclone chamber, but by the cost of the pumping system required to deliver the flow.

A benefit of the mixing device 20 of the present invention is that any liquid that is present inside the pressure chamber during one of the adjustments of removing or adding the resistant plugs 32 falls back into the pressure chamber/cyclonic chamber when a center cartridge 26 is lifted out, leaving the cartridge and the flow free of spills.

While delivering the wastewater stream into the mixing device 20, liquid or solid additives may be injected at a controlled rate. This allows the system to be tuned to the energy conversion characteristics (conversion of pressure to centrifugal force) and modify the diameter and length of the central gas column in the down tube 34 of the mixing apparatus 20. Thus, the system, typically at the mixing device 20 includes an inlet port 36 for the introduction of gas or chemicals, and another import 38 which can also introduce either gas or chemicals into a wastewater spring. When using the mixing apparatus 20 as a liquid solid mixer, the liquids and/or solids are usually added into the stream on the high-pressure side of the device 20. These components are mixed by accelerating through the ports 38, as well as by the centrifugal forces acting in the tangential holes 28 and in the spinning column of fluid in the down tube 34. In practice, opening or closing some of the tangential ports 28, as well as lowering or increasing the inlet pressure, can manage the magnitude of mixing forces. It has been found that most contaminants, and their corresponding charge satisfaction additive have a mixing energy sweet spot where flocculation performance is enhanced. Tuning the mixing energy is a significant, but up to now overlooked, component of DAF flotation system design.

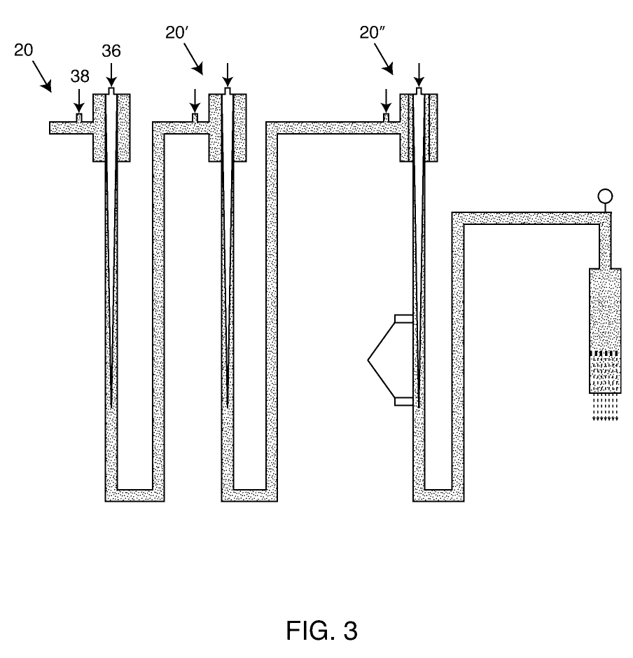

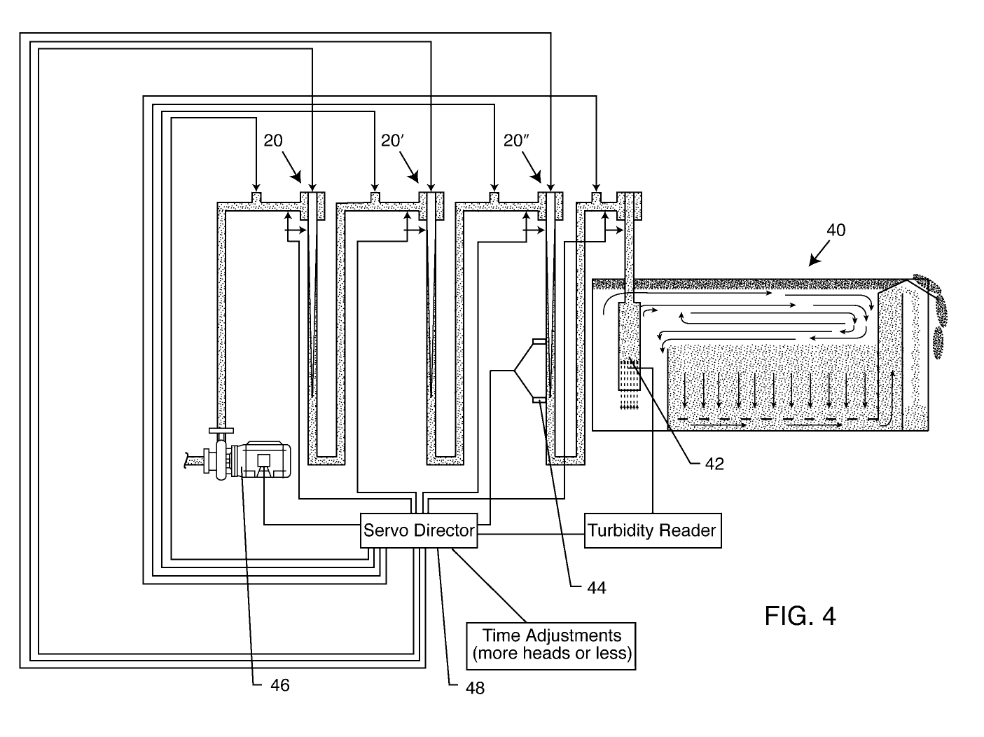

With reference now to FIG. 3, if necessary, a series of mixing devices 20, 20′, 20″ may be configured to allow sequential injection of chemicals at optimum mixing energy for each chemical constituent individually. Multiple gas dissolving vortex exposures may be used to optimize the energy of the gas-mixing vortex if there is not sufficient to saturate the stream as a result of soft chemical mixing energy. The number, setting and placement of the mixing units 20 is determined by a bench test analysis, as will be more fully described herein. The liquid/solid chemicals are added to the stream entrance and the settings of each are fine-tuned for each unit by measuring the resulting turbidity of the water discharged into a flotation tank 40, as illustrated in FIG. 4.

When the treated water is discharged into the flotation tank 40, it may pass through a pressure regulating apparatus 42, such as a cavitation plate, as more fully disclosed in U.S. Application Serial Nos. 10/810,295 and 10/810,928.

With continuing reference to FIG. 4, in addition to simultaneously delivering liquid or solid additives into the wastewater stream at a controlled rate, the system of the present invention can modify the diameter and length of the central-column in the down tube of each apparatus 20 by utilizing sensors 44 which measure the length of the central gas column in the device on the mixing apparatus 20. By sensing where the central gas column terminates, the physical shape of the vortex may be manipulated by adding more or less gas to the central vortex, such as through port 36. If the vortex position is established, it may be maintained by sensing its location visually, sonically, electronically, or otherwise by adding replenishment gas to replace the gas that gets adsorbed into the liquid and carried downstream to the nucleation chamber 40. It will be appreciated that the gas may be added in a steady or pulsed manner.

As shown in FIG. 4, an in-line adjustable flow pump 46 is used to control the flow, and in turn the pressure drop, and thus the energy across the system. The flow may also be adjusted by inserting a flow control valve on the high pressure side of the water pump 46.

A servo director controller 48 is electronically linked to the various valves, input ports, sensors, and pump so as to adjust the rate of flow into the mixing devices 20, the number of mixing devices 20 through which the liquid wastewater stream is passed, the amount of liquid and gas chemical additives, etc. This is intended to at least partially automate the adjustment of the system parameters.

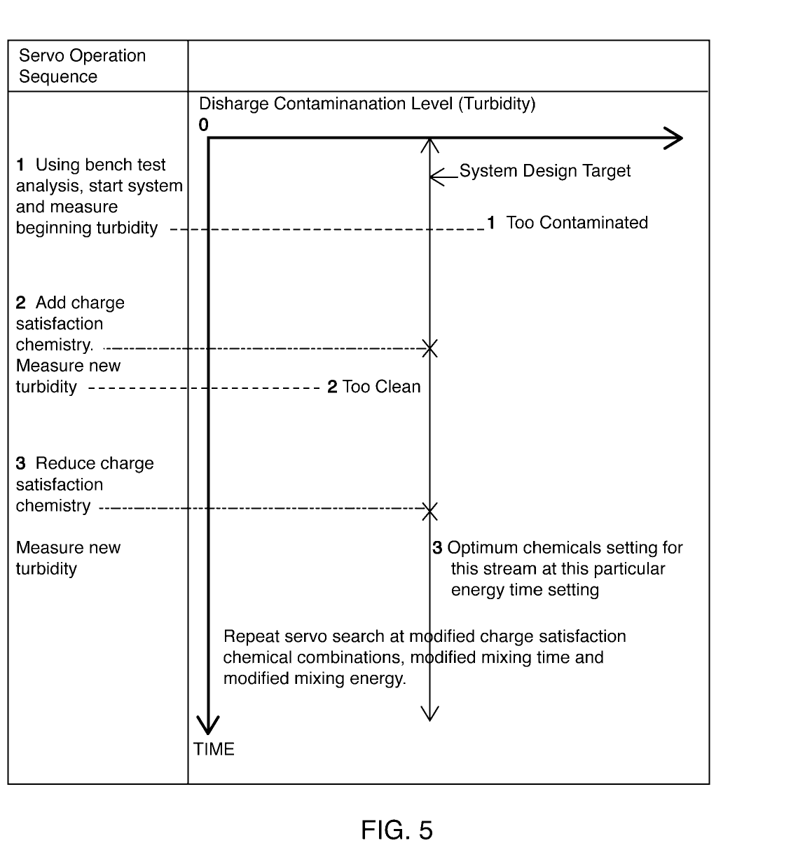

With reference now to FIG. 5, in a typical optimization procedure, the wastewater pH is pre-adjusted to optimum (typically close to the pH at which particles are not highly charged to reduce usage of treatment chemicals). The pH adjustment will typically be performed with the addition of sodium hydroxide or sulfuric acid. Standard jar tests, which are well known to those skilled in the art, are used to establish the pH at which the minimum amounts of chemicals are used to coagulate and flocculate the wastewater contaminants effectively. Low molecular weight coagulants can then be added to the wastewater sample and premixed to nearly neutralize the charge, or slightly overcharge the particles. This is necessary to leave some charge so that either flocculants of the same charge or opposite charge can be adsorbed on preformed coagulated flocs and cause the growth of such flocs.

In some cases, subsequent addition of flocculants of opposite charge yields larger, stronger flocs. For instance, the pH of motor oil in water emulsion (0.2% oil) can be adjusted to 7. Then 50 ppm of cationic polyamine coagulant can be added to nearly neutralize the charge. Then 10 ppm of cationic polyacryalamide flocculant can then be added to slightly overcharge the pin flocs and begin flocculation. An anionic polyacryalamide (10 ppm) can subsequently be added to form large, stable flocs. Thus, the sequence of addition is pH-cationic coagulant-cationic flocculant-anionic flocculant. As shown in FIG. 5, there is a system design target, and a bench test analysis is used to determine the optimal amount of charge satisfaction chemistry so as to optimize the removal of the contaminants from the stream water, while not utilizing too much expensive chemistry. Also, as shown above, adding excessive chemistry can actually reduce the effectiveness of the system.

After determining the first variable, utilizing the bench test analysis of the stream, this process is repeated by varying the next variable. The servo controller 48 can then be programmed with this information, so as to adjust the variable accordingly.

The control system can be set up to administer each of these chemical constituents with a mixing time and mixing energy that is optimized by trial and error for each individual chemical component as it is introduced into the wastewater streams. The addition of a gas source and a gas control loop on one or each of the mixing apparatuses 20, permits the simultaneous entrainment of dissolved gas to any required level for the formation of nucleation sites where bubbles will later form inside the structure of the floc. Using the servo control system to optimize the step ensures maximized performance with minimal chemical costs. Most all DAFs deliver pre-formed bubbles to pre-formed flocs. These bubbles are mostly too large to form attachments to the flocs. The attachments that do form are made on the outside of the floc structures, where they can be easily dislodged. The attachments that are made using the present invention are formed within the floc structure as they evolve and become physically incorporated into the floc filaments as they attach to each other. These gases (nanobubbles) that are entrapped inside the evolving flocs are the sites where dissolved gas will eventually deposit as the pressure of the mixing system is decreased. Large buoyant bubbles form, which will carry the flocs to the surface of the water of the flotation tank 40. As the bubbles grow, they also mechanically displace a great deal of water from the structure of the flocs, making the floc even more buoyant.

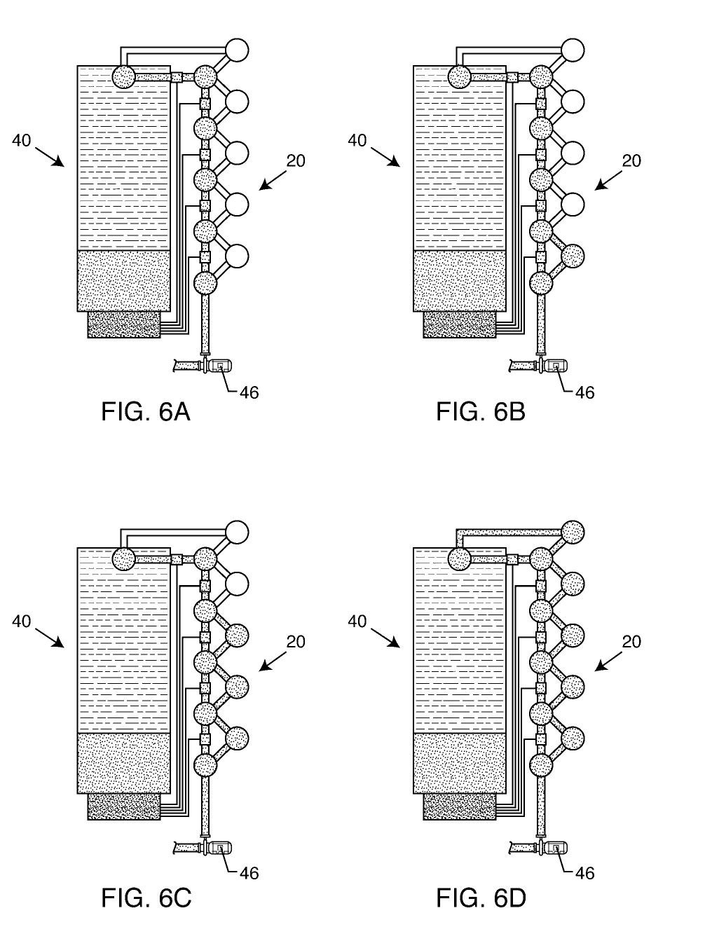

With reference to FIGS. 6A-6D, a diagrammatic view is shown of the pump 46 fluidly communicating with a plurality of mixing apparatuses 20 which eventually empty into the flotation tank 40. As illustrated, the rotational energy applied to the liquid/chemical subjected to mixing, and particularly the time of mixing, can be adjusted by opening or closing valves to the mixing devices 20, such that the wastewater stream passes through a greater or lesser number of mixing devices 20.

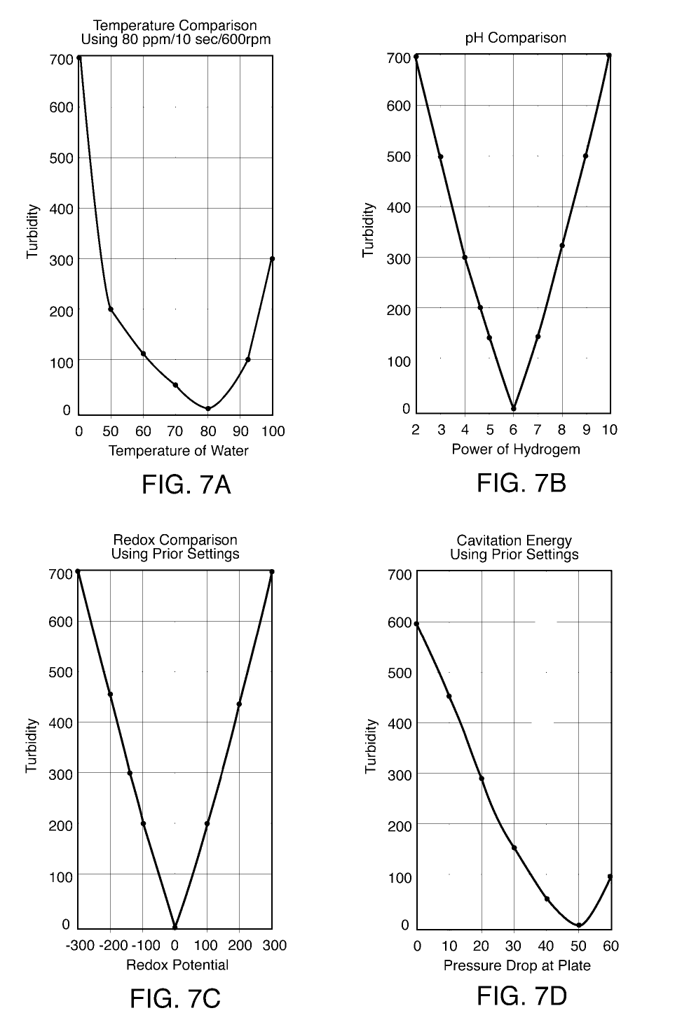

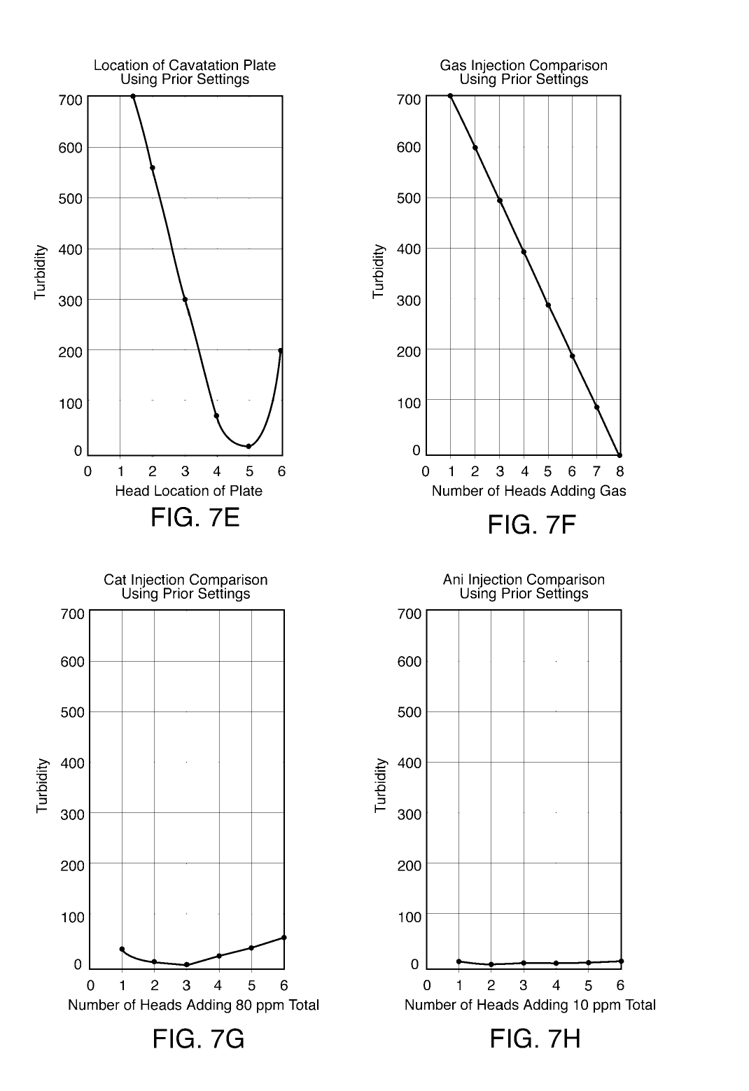

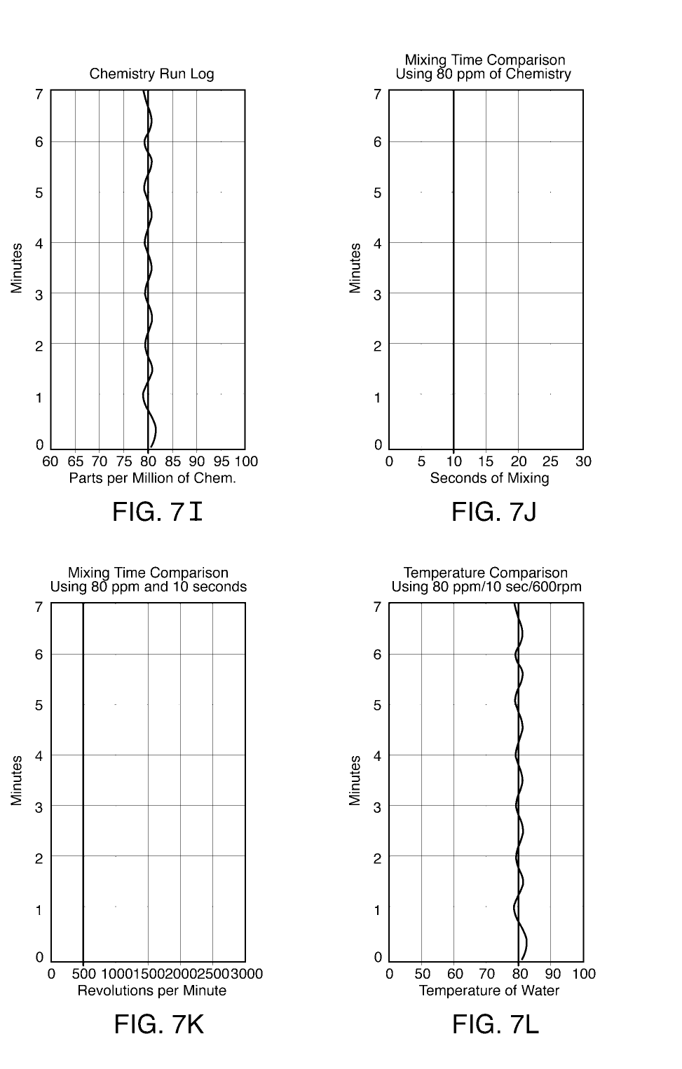

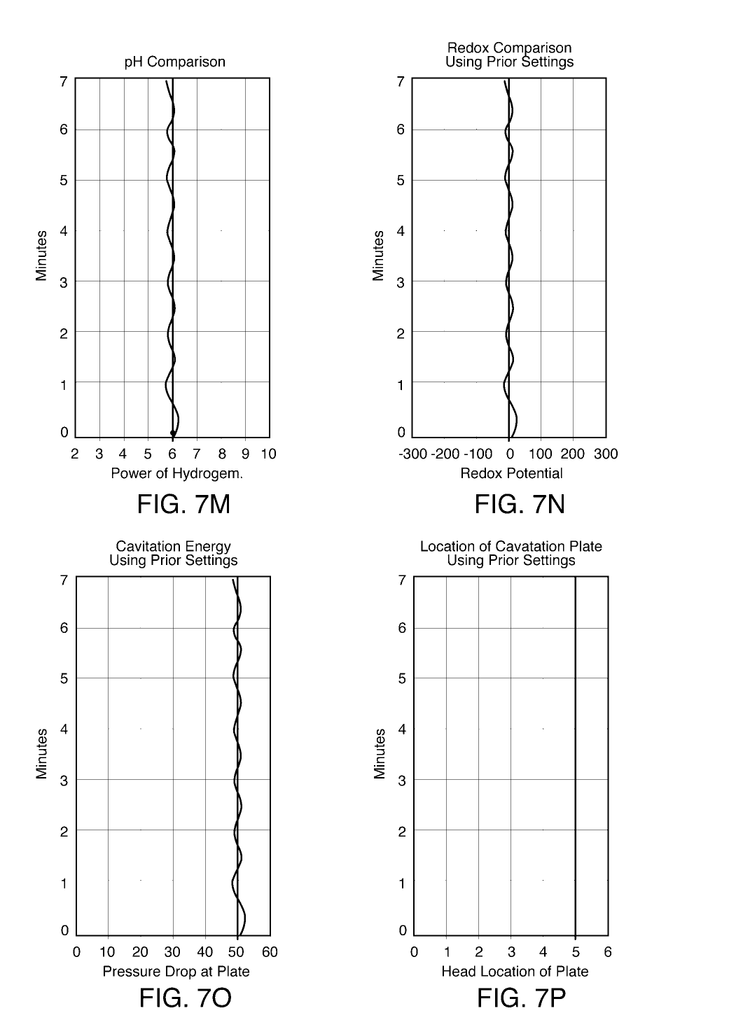

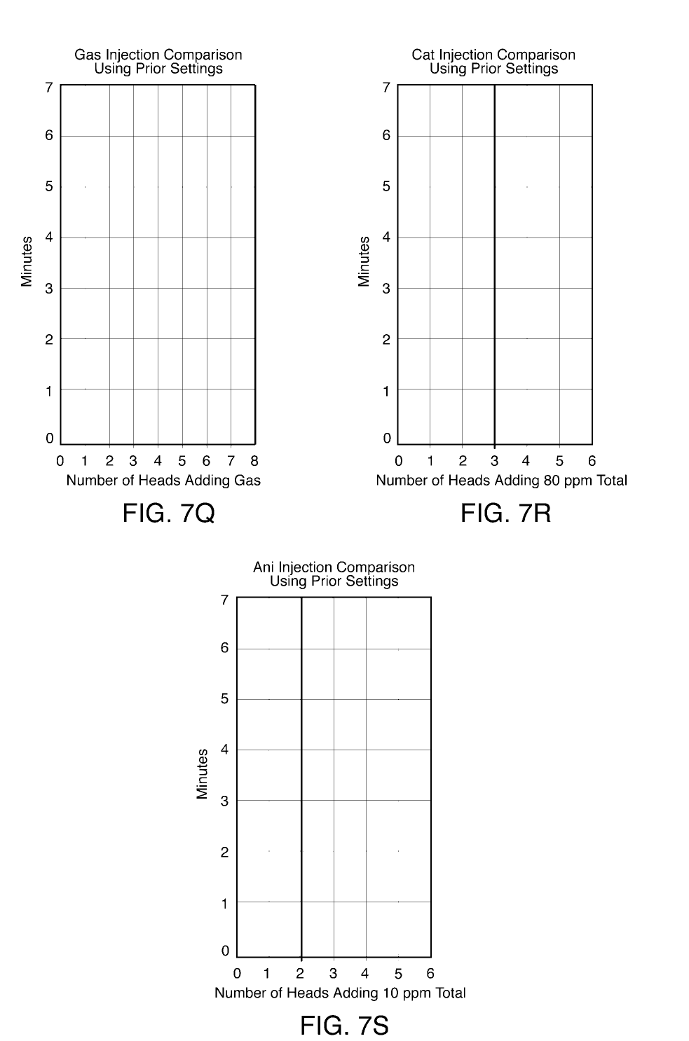

With reference to FIG. 7, there are many design energy variables to be considered. These include chemical additives, amount of chemical additive, sequence of chemical additives, amount of mixing energy, sequence of mixing energy, cavitation energy sequence, amount of cavitation energy, fluid rate of flow, and average temperature of stream at each energy or mixing station. Each of these is tested, such as using the bench test analysis procedures as described above, to determine the optimal results for the particular wastewater stream. The results of such optimization tests for a given wastewater stream is illustrated in FIGS. 7A-7S.

The system of the present invention can be changed either in automated or manual fashion to alter these variables. For example, various bubble nucleation pressures can be delivered, such as 0.5 to 150 psi. Cavitation plates varying in hole sizes can be inserted at various spots in the system as needed to achieve depressurization. The control system of the present invention can also optimize, as the stream changes, the amount and type of chemistry added, the frequency of additions of any type of chemical constituent, where the chemical additions yield the best flocs, the sequence of chemical additions, rotational energy and mixing, amount of gas delivered and dissolved and the liquid, and the amount of energy that is left over in the fluid that will be made available for downstream double nucleation. Other variables which can be easily manipulated include pH, redox potential and temperature. Various bench test procedures can be performed throughout the day and programmed into the controller 48 such that these variables are changed as needed, or the overall system is programmed so as to fluctuate throughout the course of a manufacturing period to accommodate the differences in the characteristics and constituents of the wastewater stream.

Although several embodiments have been described in detail for purposes of illustration, various modifications may be made to each without departing from the scope and spirit of the invention. Accordingly, the invention is not to be limited, except as by the appended claims.

1. A method for removing contaminants from a liquid stream, comprising the steps of:
obtaining samples from the contaminated liquid stream, and performing a bench test analysis on the samples for a plurality of treatment variables establish an optimal parameter for each variable;
passing the contaminated liquid stream through a treatment system including at least one mixing device, an inlet port for chemical additives, and a flotation tank; and
modifying the variables, including chemical additives, as the contaminated liquid stream changes.
